(19) United States
(12) Patent Application Publication
(10) Pub. No.: US 2014/0198242 A1
(43) Pub. Date: Jul. 17, 2014

(54) IMAGE CAPTURING APPARATUS AND IMAGE PROCESSING METHOD

(71) Applicant: BENQ CORPORATION, Taipei City (TW)

(72) Inventors: Jen-Shiun Weng, Taipei City (TW); Chia-Nan Shih, Taipei City (TW); Yi-Ting Chou, Taipei City (TW)

(73) Assignee: BENQ CORPORATION, Taipei City (TW)

(21) Appl. No.: 13/743,360

(22) Filed: Jan. 17, 2013

(30) Foreign Application Priority Data
Jan. 17, 2013 (TW) 101101832

(51) Int. Cl. H04N 5/232

(52) U.S. Cl. CPC H04N 5/23293
USPC 348/333.09

(57) ABSTRACT

An image capturing apparatus and an image processing method are disclosed. The image capturing apparatus includes an image capturing module, a micro processor, and a display module. The image capturing module continuously captures images corresponding to different focus distances. The display module displays an initial display image of the images. The micro processor divides the initial display image into a plurality of lattice areas and uses one of the plurality of lattice areas as a specific lattice area. The micro processor compare sharpness values of areas corresponding to the specific lattice area in the plurality of images corresponding to the different focus distances to generate a comparison result and selects a first image from the plurality of images according to the comparison result. The display module displays the first image to replace the initial display image previously displayed.

### BACKGROUND OF THE INVENTION

1. Field of the Invention

The invention relates to image capturing; in particular, to an image capturing apparatus and an image processing method applied to the image capturing apparatus.

2. Description of the Prior Art

In recent years, with the development of image technology and photographic equipments, various kinds of digital cameras have been widely used in our daily life and become a popular electronic product at the consumer market.

Current digital cameras have auto-focusing function, however, no matter the digital camera uses single-point focusing function or multi-point focusing function, or even has additional face tracking function or object tracking function, it still happens that the focus point selected by the digital camera system is not the focus point the user wants.

In addition, if the user wants to use current digital camera to obtain different depth of field effects generated by using different focus points to focus in the same photo respectively, the user often has to shot several times to obtain photo having different depth of field effects. For the digital camera user, the current digital camera is still not simple and convenient enough to use.

### SUMMARY OF THE INVENTION

Therefore, the invention provides an image capturing apparatus and an image processing method applied to the image capturing apparatus to solve the above-mentioned problems occurred in the prior arts.

An embodiment of the invention is an image capturing apparatus. In this embodiment, the image capturing apparatus includes an image capturing module, a micro processor, and a display module. The micro processor is coupled to the image capturing module and the display module. The image capturing module continuously captures images corresponding to different focus distances. The display module displays an initial display image of the images. The micro processor divides the initial display image into a plurality of lattice areas and uses one of the plurality of lattice areas as a specific lattice area. The micro processor compare sharpness values of areas corresponding to the specific lattice area in the plurality of images corresponding to the different focus distances to generate a comparison result and selects a first image from the plurality of images according to the comparison result. And then, the display module will display the first image to replace the initial display image previously displayed.

In practical applications, if a central lattice area or a lattice area corresponding to a focus indicator box of an image among the plurality of images has a maximum sharpness value, the image is selected as the initial display image. The comparison result generated by the micro processor is shown in a sharpness-focus distance distribution curve and the first image is selected from the plurality of images according to a best focus distance corresponding to a maximum sharpness value of the sharpness-focus distance distribution curve.

In practical applications, when the display module displays the selected first image and the plurality of lattice areas of the first image and another specific lattice area of the plurality of lattice areas is selected, the micro processor compares the sharpness value of the another specific lattice area in each image to generate another comparison result and selects a second image from the plurality of images according to the another comparison result, and then the display module displays the second image selected to replace the first image previously displayed. The second image is different from the first image.

In practical applications, the micro processor divides each of the plurality of images into the plurality of lattice areas respectively and calculating the sharpness value in each of the plurality of lattice areas respectively, after the sharpness value of each lattice area is calculated by the micro processor, the micro processor judges whether sharpness values of all lattice areas of at least two adjacent images of the plurality of images are the same; if the judgment result is yes, the micro processor cancels one of the images having the same sharpness values of all lattice areas; if the judgment result is no, the micro processor keeps some of the images having different sharpness values of all lattice areas.

In practical applications, the micro processor divides the initial display image into the plurality of lattice areas in a way that the plurality of lattice areas divided can be selected respectively and when a lattice area is selected from the plurality of lattice areas, the micro processor uses the selected lattice area as the specific lattice area.

Another embodiment of the invention is an image processing method applied to an image capturing apparatus. In this embodiment, the image processing method comprising steps of: continuously capturing a plurality of images corresponding to different focus distances; selecting one of the plurality of images as an initial display image and dividing the initial display image into a plurality of lattice areas; using a specific lattice area of the plurality of lattice areas in the initial display image to compare sharpness values of areas corresponding to the specific lattice area in the plurality of images corresponding to the different focus distances to generate a comparison result; selecting a first image from the plurality of images corresponding to the different focus distances according to the comparison result and displaying the first image selected to replace the initial display image previously displayed.

Compared to the prior art, the image capturing apparatus and the image processing method applied to the image capturing apparatus of the invention are to capture a plurality of images corresponding to different focus distances respectively, and then divide each image into a plurality of lattice areas and calculate sharpness value of each lattice area for the user to select the lattice area to be focused, and automatically find the best focus distance corresponding to the selected lattice area and the clearest image corresponding to the best focus distance and then display the clearest image. Therefore, complicated operation procedures are unnecessary when the user takes pictures. The user only needs to select the auto-focusing process, the high-speed focusing process, or video recording process, and then press the shutter button down halfway (the auto-focusing process) or fully press the shutter button (the high-speed focusing process or video recording process) to take pictures having different focus points for the same scene. When the user wants to view the pictures corresponding to different selected focus point positions, the user only needs to select different lattice areas on the monitor of the digital camera, an then the monitor will display pictures having different shallow depth of field effects for the user to select one.

The advantage and spirit of the invention may be understood by the following detailed descriptions together with the appended drawings.

### BRIEF DESCRIPTION OF THE APPENDED DRAWINGS

FIG. 1 illustrates a schematic diagram of the image capturing apparatus in an embodiment of the invention.

FIG. 2 illustrates a schematic diagram of capturing the first image through the sixth image at the first focus distance through the sixth focus distance respectively.

FIG. 3 illustrates a schematic diagram of dividing each image into 9 lattice areas respectively.

FIG. 4 illustrates a schematic diagram of the user using a finger touching way to select the specific lattice area R6 to be focused from the lattice areas R1˜R9.

FIG. 5 illustrates sharpness value-focus distance distribution curves C_{R1}˜C_{R9} corresponding to the lattice areas R1˜R9 respectively.

FIG. 6 illustrates an enlarged schematic diagram of the distribution curve C_{R6} in FIG. 5.

FIG. 7 illustrates a schematic diagram of the display module displaying the selected fourth image M4.

FIG. 8A and FIG. 8B illustrate the flowchart of the image capturing method in another embodiment of the invention.

### DETAILED DESCRIPTION OF THE INVENTION

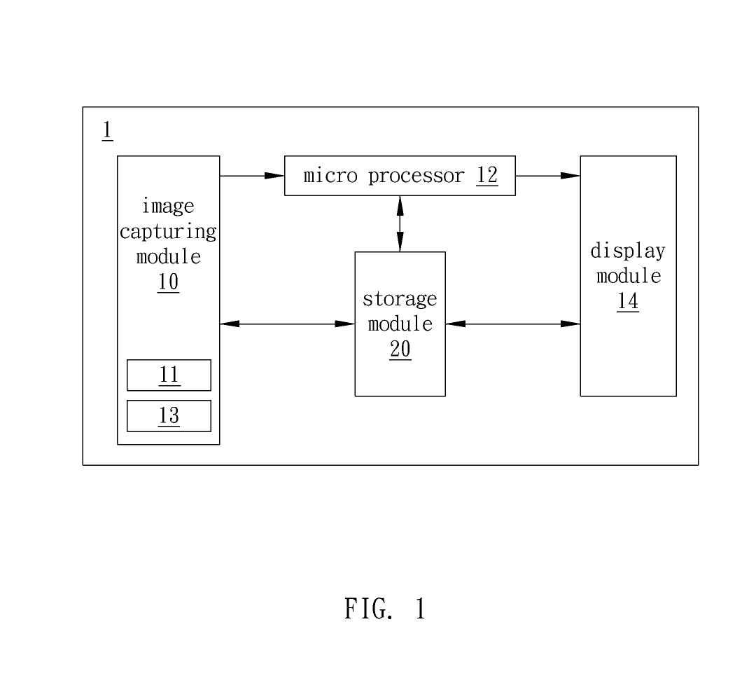

An embodiment of the invention is an image capturing apparatus. In practical applications, the image capturing apparatus can be a digital camera, a mobile phone, or other electronic apparatus having camera functions, but not limited to this. Please refer to FIG. 1. FIG. 1 illustrates a schematic diagram of the image capturing apparatus.

As shown in FIG. 1, the image capturing apparatus 1 includes an image capturing module 10 having a charge-coupled device (CCD) 11 and a zoom lens 13, a micro processor 12, a display module 14, and a storage module 20. Wherein, the micro processor 12 is coupled to the image capturing module 10, the display module 14, and the storage module 20.

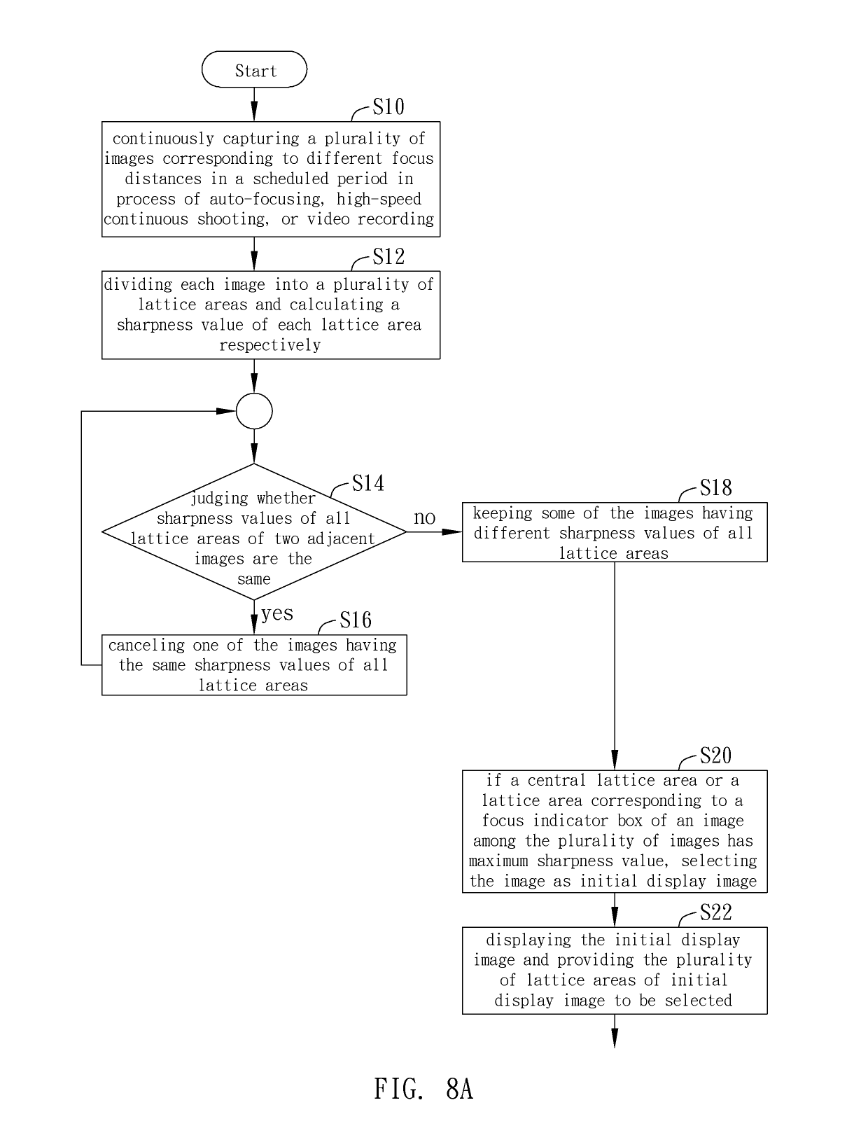

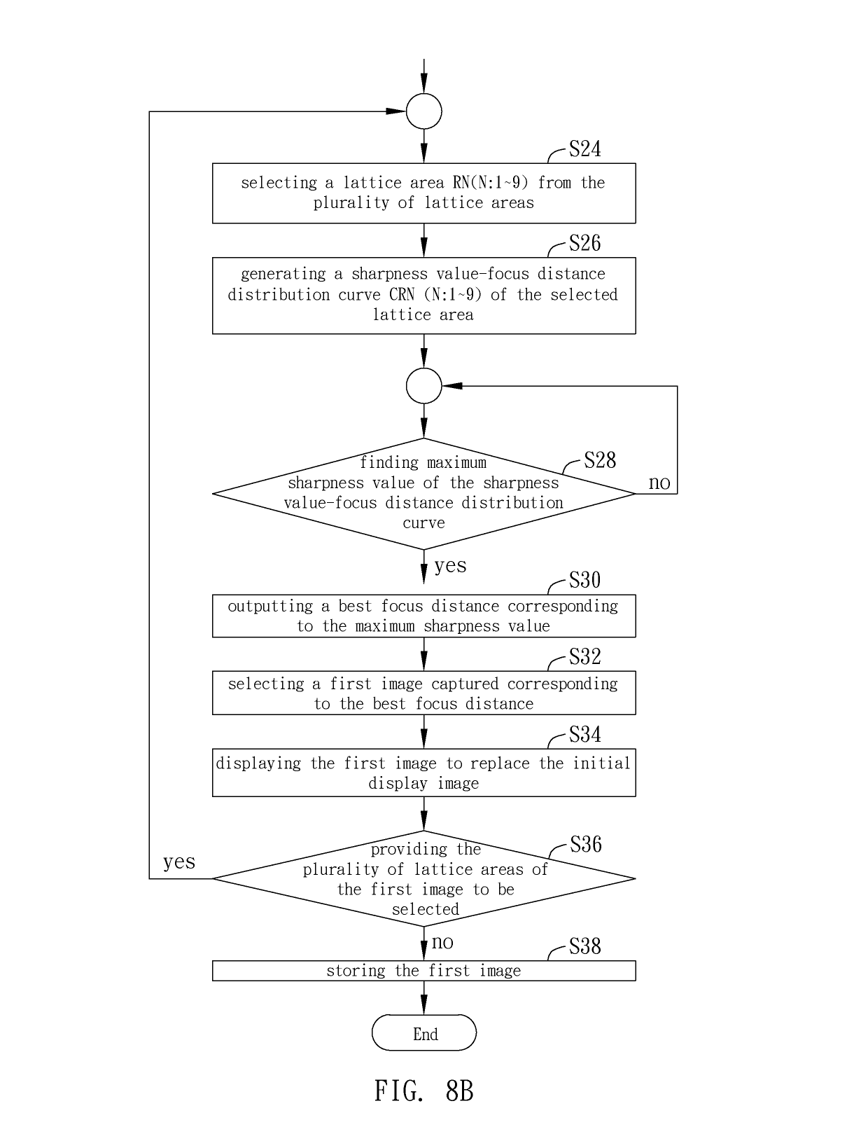

Then, the modules of the image capturing apparatus 1 and their functions will be introduced in detail. Please refer to the flowchart of the image capturing method (FIG. 8A and FIG. 8B).

In this embodiment, after the user press the shutter button, the image capturing module 10 will continuously capture a plurality of images corresponding to different focus distances in a scheduled period respectively. The scheduled period is already known. In the scheduled period, the zoom lens 13 moves to positions corresponding to different focus distances in order, and after the CCD 11 captures the image corresponding to the focus distance, the zoom lens 13 continuously moves to the position corresponding to next focus distance for the CCD 11 to capture next image until the CCD 11 captures images corresponding to all focus distances. The scheduled period should be small enough to avoid the situation that the subject and ground have larger movement and change.

In practical applications, the image capturing module 10 can use auto-focusing process, high-speed focusing process, or video recording process to capture the images corresponding to different focus distances (step S10). The images can be VGA images having lower resolution (640×480) or the image form having higher resolution, for example, 1080p form image having resolution (1920×1080), but not limited to this. The storage module 20 can be DRAM or other types of memory for storing images captured by the image capturing module 10 without specific limitations.

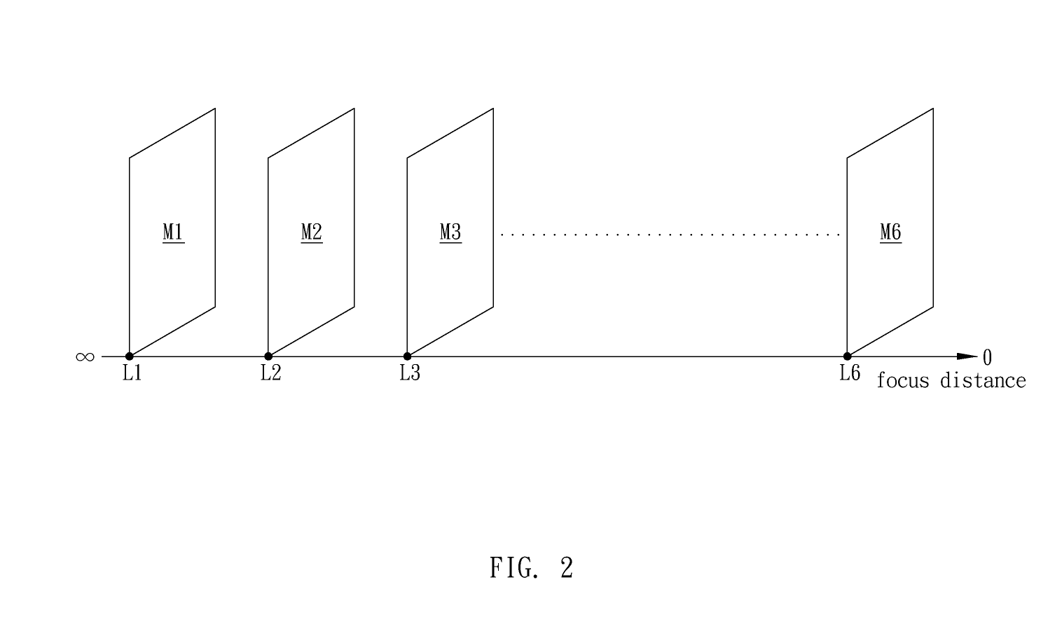

Ii is assumed that the image capturing module 10 performs the auto-focusing process under the mode of pressing shutter button down halfway to capture a plurality of images corresponding to different focus distances. In the auto-focusing process, the zoom lens 13 of the image capturing apparatus 1 will automatically scan from the furthest focus distance (infinite) to the nearest focus distance and capture images at some focus distances. For example, as shown in FIG. 2, the image capturing module 10 captures six images (the first image M1˜the sixth image M6) at the first focus distance L1˜the sixth focus distance L6 respectively, but not limited to this. In fact, the arrangement of the first focus distance L1˜the sixth focus distance L6 can be equidistant or not without specific limitations. For example, the six focus distances can be infinite (∞), 50 m, 5 m, 1 m, 20 cm, and 5 cm, but not limited to this.

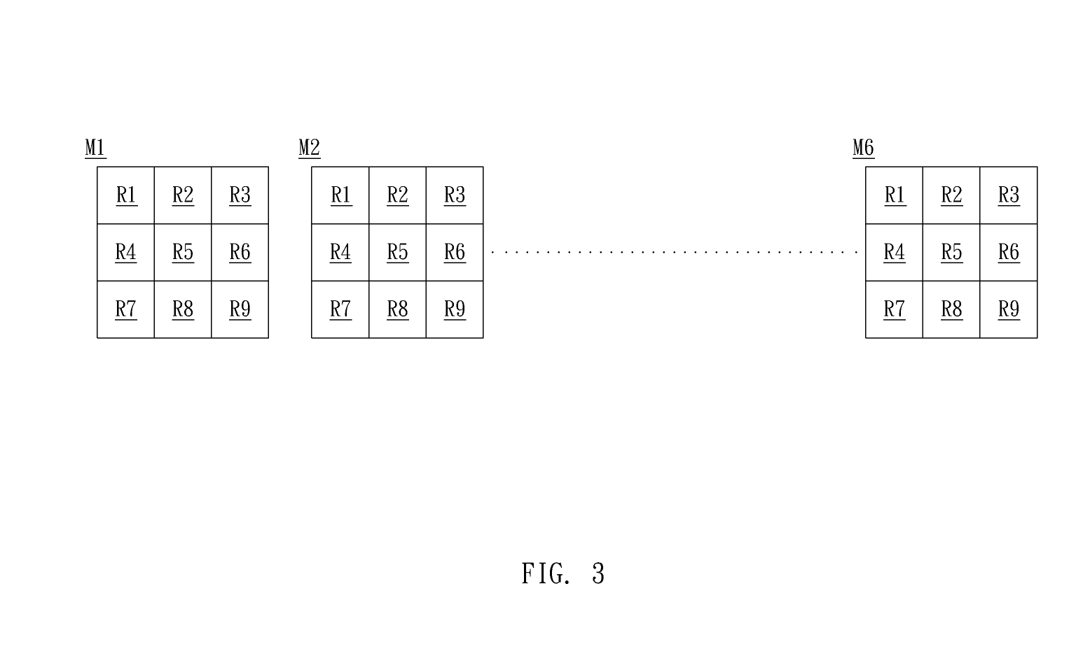

Then, the micro processor 12 divides each image M1˜M6 into a plurality of lattice areas respectively, and calculates the sharpness value of each lattice area respectively (the step S12). In a preferred embodiment, each image M1˜M6 is divided into (A*B) lattice areas respectively, wherein A and B are both positive integers. As shown in FIG. 3, each image M1˜M6 is divided into nine lattice areas R1˜R9, but not limited to this. In fact, how many lattice areas the micro processor 12 should divide the images M1˜M6 can be determined according to practical needs of the user. If the micro processor 12 divides the images M1˜M6 into more lattice areas, the quality of the final image may be better; however, the micro processor 12 has to use longer time and more resource to process.

In practical application, the micro processor 12 can use different ways to calculate sharpness values of the lattice areas R1˜R9 without specific limitations. For example, pixels of red (R), green (G), and blue (B) are arranged in each lattice area R1˜R9 respectively. Since human eyes are most sensitive to the green light, the micro processor 12 generally uses the green pixel to calculate sharpness values. All grey-level values of adjacent green pixels are subtracted from each other and then taken the absolute value by the micro processor 12 as Equation (1) shown below to obtain sharpness values of the lattice areas R1˜R9 respectively. The larger the sharpness value of certain lattice area, the clearer the image corresponding to the lattice area.

Sharpness value S=(Σ|I₁−Iᵢ|)/N(i=219 N) Equation (1)

For example, if 4 green pixels of the lattice area R1 are adjacent arranged in a (2*2) matrix and their grey-level values are I₁, I₂, I₃, and I₄ respectively, the sharpness value of the lattice area R1 is S_{R1}=(|I₁−I₂|+I₁-I₃|+I₁-I₄|)/3 [symbol] If there is more green pixels in the lattice area R1, the above-mentioned calculation way can be referred to calculate the sharpness value of the lattice area R1.

It should be noticed that since the micro processor 12 will further compare the sharpness values of the lattice area corresponding to different images, the micro processor 12 has to divide the images M1˜M6 into lattice areas in the same number and size for convenience. And, since the plurality of lattice areas divided will be selected by the user, the micro processor 12 has to divide the initial display image into the plurality of lattice areas in a way that the plurality of lattice areas divided can be selected respectively.

After the micro processor 12 calculates the sharpness values of the lattice areas R1˜R9 of each image M1˜M6, the micro processor 12 will judge whether the sharpness values of all lattice areas of an image are the same with the sharpness values of all lattice areas of another image adjacent to the image (the step S14). If the judgment of the micro processor 12 is yes, the micro processor 12 will cancel one of them (the step S16). For example, if the micro processor 12 determines that the sharpness values of all lattice areas R1˜R9 of the third image M3 are the same with the sharpness values of all lattice areas R1˜R9 of the fourth image M4, then the micro processor 12 will cancel the third image M3 or the fourth image M4 to reduce the following operation loading of the image capturing apparatus 1.

If the judgment of the micro processor 12 is no, the micro processor 12 will keep both of them (the step S18). Then, if a central lattice area or a lattice area corresponding to a focus indicator box of an image among the plurality of images has maximum sharpness value, the micro processor 12 will select the image as initial display image (the step S20). The display module 14 will display the initial display image and provide the plurality of lattice areas of the initial display image to be selected (the step S22). In fact, the user can also select a default lattice area to be focused before the images are captured by the image capturing module 10.

In practical applications, the display module 14 can be a monitor. If the central lattice area (R5) of one image among the images M1˜M6 has maximum sharpness value, the image can be displayed by the display module 14 to be the initial display image. For example, if the sharpness values of the central lattice area R5 of the first image M1˜the sixth image M6 are 20, 15, 12, 19, 14, and 17 respectively, since the sharpness value 20 of the central lattice area R5 of the first image M1 is the highest among the first image M1˜the sixth image M6, the display module 14 will display the first image M1 as the initial display image and display the lattice areas R1˜R9 of the first image M1 for the user to select one to be focused. The lattice lines of the lattice areas R1˜R9 of the first image M1 can be shown in solid line, dotted line, or hidden line.

In addition, if the lattice area corresponding to the focus indicator box of one image among the images M1˜M6 has maximum sharpness value, the image can be displayed by the display module 14 to be the initial display image. For example, if the focus indicator box corresponds to the lattice area R5, and the sharpness values of the lattice area R5 of the first image M1˜the sixth image M6 are 14, 11, 27, 19, 12, and 22 respectively, since the sharpness value 27 of the lattice area R5 of the third image M2 is the highest among the first image M1˜the sixth image M6, the display module 14 will display the third image M3 as the initial display image and display the lattice areas R1˜R9 of the third image M3 for the user to select one to be focused. The lattice lines of the lattice areas R1˜R9 of the third image M3 can be shown in solid line, dotted line, or hidden line.

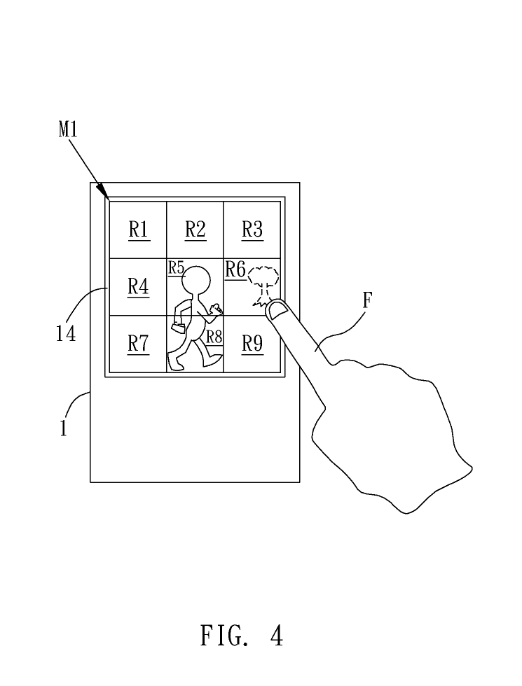

At this time, as shown in FIG. 4, it is assumed that the initial display image displayed by the display module 14 is the third image M3, and the lattice area R5 of the third image M3 has a clear human image and the lattice area R6 of the third image M3 has a vague distant background tree shadow. The user can use his/her finger F to touch the display module 14 or press direction buttons to select specific lattice area to be focused from the lattice areas R1˜R9 (the step S24); for example, the specific lattice area is lattice area R6. Then, the micro processor 12 will compare the sharpness values of the specific lattice area R6 of the first image M1˜the sixth image M6 to generate a comparing result. In practical application, the comparison result generated by the micro processor 12 can be shown in a sharpness-focus distance distribution curve (the step S26), but not limited to this.

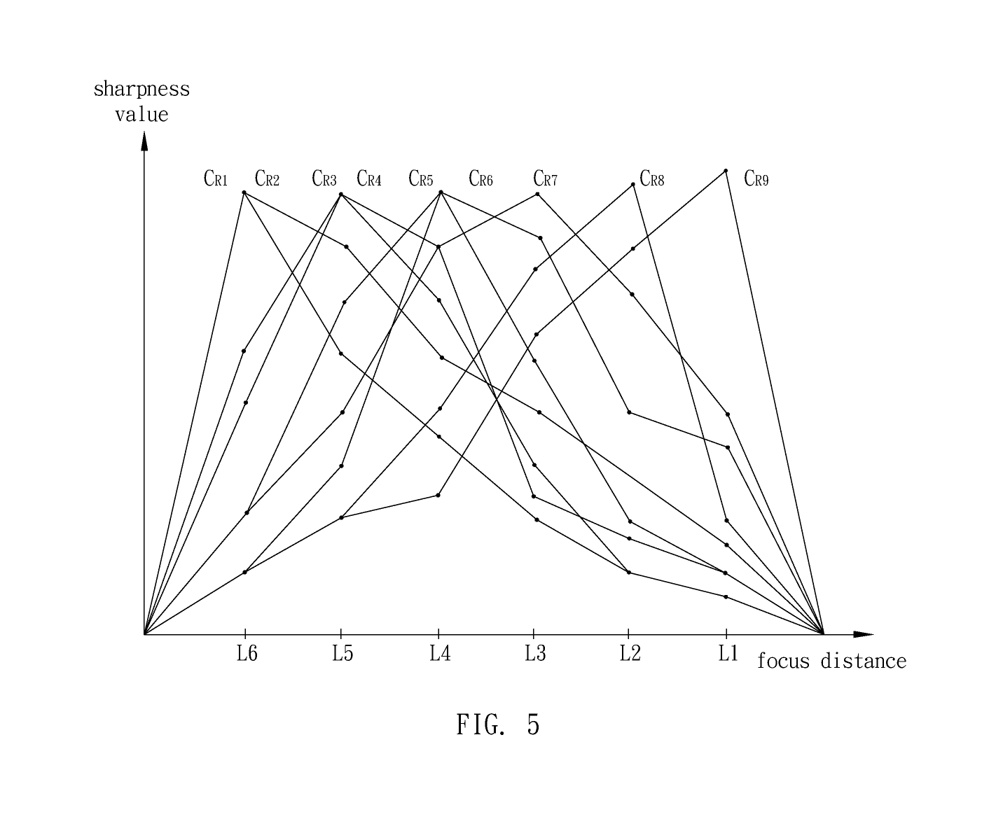

Please refer to FIG. 5. FIG. 5 illustrates sharpness value-focus distance distribution curves corresponding to the lattice areas R1˜R9 respectively. As shown in FIG. 5, the distribution curves C_{R1}-C_{R9} represent the sharpness value-focus distance distribution curves corresponding to the lattice areas R1˜R9 respectively. Wherein, the distribution curve C_{R1} is formed by the sharpness values corresponding to the lattice areas R1 of the images M1˜M6; the distribution curve C_{R2} is formed by the sharpness values corresponding to the lattice areas R2 of the images M1˜M6; the distribution curve C_{R3} is formed by the sharpness values corresponding to the lattice areas R3 of the images M1˜M6, and so on.

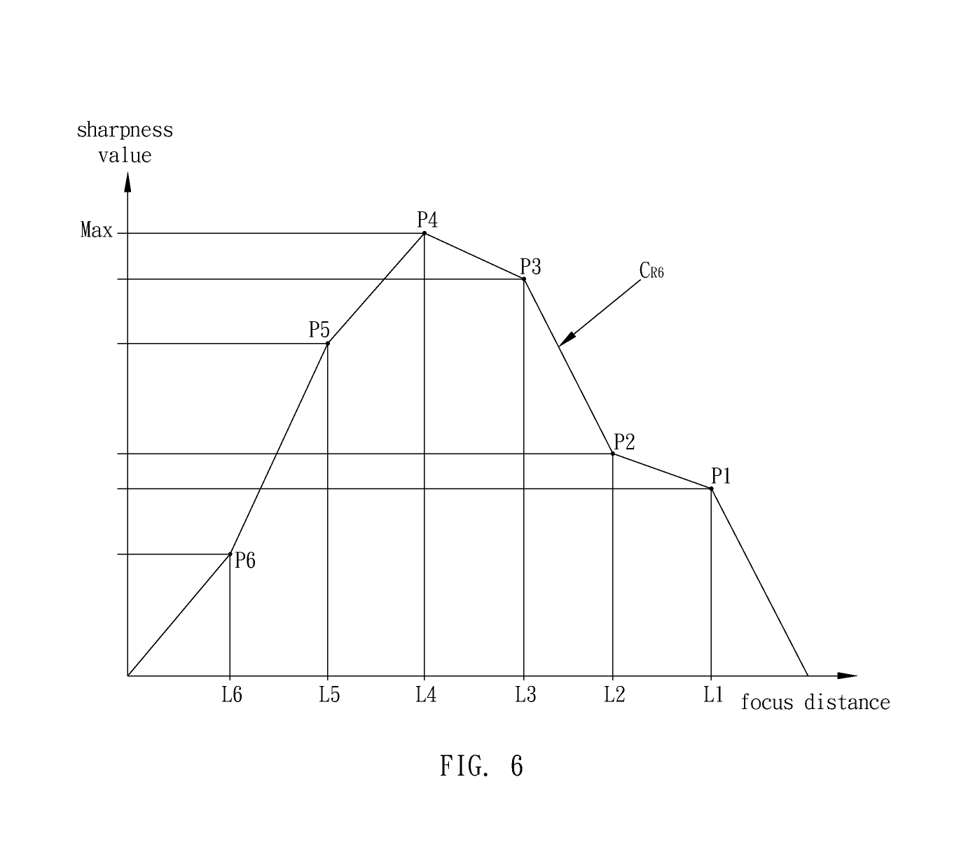

The distribution curve C_{R6} shown in FIG. 5 is the comparing result generated after the micro processor 12 compares the sharpness values of the specific lattice area R6 of the first image M1˜the sixth image M6. Please refer to FIG. 6. FIG. 6 illustrates an enlarged schematic diagram of the distribution curve C_{R6} in FIG. 5. As shown in FIG. 6, the distribution curve C_{R6} is the sharpness value-focus distance distribution curve corresponding to the specific lattice area R6, and the distribution curves C_{R6} has points P1˜P6 corresponding to the image M1˜M6 respectively. Wherein, the point P1 corresponds to the sharpness value of the specific lattice area R6 in the first image M1 (captured by the image capturing module 10 at the first focus distance L1); the point P2 corresponds to the sharpness value of the specific lattice area R6 in the second image M2 (captured by the image capturing module 10 at the second focus distance L2); the point P3 corresponds to the sharpness value of the specific lattice area R6 in the third image M3 (captured by the image capturing module 10 at the third focus distance L3), and so on.

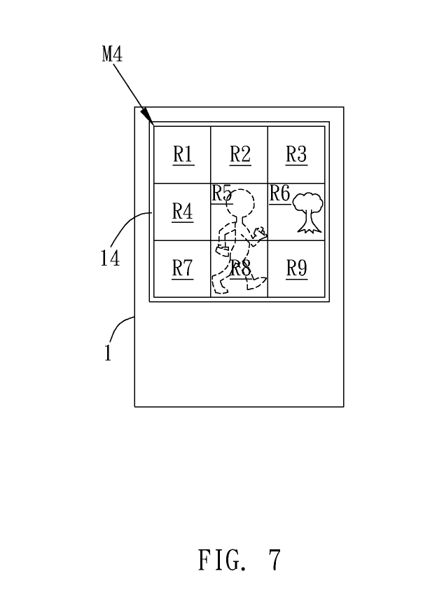

Then, the micro processor 12 will select the image corresponding to the maximum sharpness value of the sharpness value-focus distance distribution curve from the images M1˜M6 according to the above-mentioned comparison result (the step S28). According to the previous example, the micro processor 12 will output a best focus distance L4 corresponding to the maximum sharpness value Max of the distribution curve C_{R6} in FIG. 6 and select a fourth image M4 corresponding to the best focus distance L4 from the images M1˜M6 (the step S30 and the step S32). Afterward, the display module 14 will display the selected fourth image M4 to replace the initial display image (the first image M1) previously displayed in FIG. 4 (the step S34). As shown in FIG. 7, the lattice area R5 of the fourth image M4 has a vague human image and the lattice area R6 of the fourth image M4 has a clear distant background tree shadow. By doing so, the user only needs to select the specific lattice area R6 to be focused, and the image capturing apparatus 1 will automatically select the clearest image M4 from all images M1˜M6 because when the images M1˜M6 are focused on their specific lattice areas R6 respectively, the fourth image M4 has the maximum sharpness value Max and the display module 14 will display the fourth image M4.

In practical applications, after the auto-focusing process under the mode of pressing shutter button down halfway is finished, the first image M1˜the sixth image M6 can be stored in a first directory of the storage module 20 to fully store the images captured for the same scene. The best focus distances corresponding to the lattice areas R1˜R9 respectively can be stored in a texture file of the first directory or an exchangeable image file format (EXIF) information of the images M1˜M6, or stored in a video file or a multi-file format with the images M1˜M6, and all of them can be stored in the storage module 20.

When the display module 14 displays the clearest image (the fourth image M4), the display module 14 will further read all lattice areas R1˜R9 of the fourth image M4 from the storage module 20 to fully display the fourth image M4, and the user can continuously select next specific lattice area to be focused (the step S36).

If the user continuously select the lattice area R2 as the next specific lattice area, the micro processor 12 will compare the sharpness values of the specific lattice area R2 of all images M1˜M6 to generate another comparison result, and then select another image (e.g., the second image M2) from all images M1˜M6 because when the images M1˜M6 are focused on their specific lattice areas R2 respectively, the second image M2 has the maximum sharpness value and the display module 14 will display the second image M2 to replace the previously displayed fourth image M4. By doing so, the user can view photos corresponding to different focus points in the same scene respectively by selecting different specific lattice areas to be focused.

Otherwise, if the user stops selecting other lattice areas of the fourth image M4, the user can press any key of the image capturing apparatus 1 to jump out of the lattice area selection function, and the fourth image M4 displayed by the display module 14 will be stored into a second directory of the storage module 20 (the step S38) to represent that the fourth image M4 is the photo to be printed or uploaded to a website.

In an embodiment of the invention, the image capturing apparatus can be a digital camera, a mobile phone, or other electronic apparatus having camera functions, but not limited to this. FIG. 8A and FIG. 8B illustrate the flowchart of the image capturing method in this embodiment of the invention.

As shown in FIG. 8A, in the step S10, after the user press the shutter button, the method will continuously capture a plurality of images corresponding to different focus distances in a scheduled period respectively. In fact, the step S10 can be achieved in the process of auto-focusing, high-speed continuous shooting, or video recording, but not limited to this. Then, in the step S12, the method will divide each image into a plurality of lattice areas and calculate a sharpness value of each lattice area respectively. In fact, each image can be divided into (A*B) lattice areas, and A and B are both positive integers, but not limited to this.

In practical applications, after the sharpness values of all lattice areas are calculated in the step S12, in the step S14, the method can further judge whether sharpness values of all lattice areas of two adjacent images are the same. If the judgment result of the step S14 is yes, the method will cancel one of the images having the same sharpness values of all lattice areas (the step S16) to reduce the operation loading of the image capturing apparatus. If the judgment result of the step S14 is no, the method will keep some of the images having different sharpness values of all lattice areas (the step S18).

Then, in the step S20, if a central lattice area or a lattice area corresponding to a focus indicator box of an image among the plurality of images has maximum sharpness value, the method will select the image as initial display image. And, the method will display the initial display image and provide the plurality of lattice areas of initial display image to be selected (the step S22). In fact, the initial display image can be selected from the plurality of images because its central lattice area has the maximum sharpness value or its lattice area corresponding to the focus indicator box of the image has the maximum sharpness value, but not limited to this. And, the plurality of lattice areas of the initial display image can be displayed on the monitor of the image capturing apparatus for the user to select the lattice area to be focused from the plurality of lattice areas in a way of touch or pressing a button.

As shown in FIG. 8A, when a specific lattice area RN(N:1˜9) is selected from the plurality of lattice areas of the initial display image (the step S24), the method will performs the step S26 to generate a sharpness value-focus distance distribution curve CRN (N:1˜9) of the selected lattice area by comparing the sharpness values of the specific lattice area of the images. In this embodiment, the sharpness value-focus distance distribution curve CRN (N:1˜9) is only a form of showing the sharpness value comparison result generated in the step S26, but not limited to this.

Afterward, in the steps S28˜S34, the method will find maximum sharpness value of the sharpness value-focus distance distribution curve, output a best focus distance corresponding to the maximum sharpness value, select a first image captured corresponding to the best focus distance, and display the first image to replace the initial display image. In fact, in the step S28, the method can refer to FIG. 6 to output the fourth image M4 corresponding to the best focus distance L4 corresponding to the maximum sharpness value (the point P4) of the sharpness value-focus distance distribution curve C_{R6} of the specific lattice area (the specific lattice area R6 of the first image M1), but not limited to this. Wherein, the best focus distance corresponding to each lattice area can be stored in a texture file or an exchangeable image file format (EXIF) information of the plurality of images, but not limited to this. The best focus distance corresponding to each lattice area and the plurality of images can be stored in a video file or a multi-file format.

In the step S36, when the method displays the first image, the method also provides the plurality of lattice areas of the first image for the user to select. When another specific lattice area of the plurality of lattice areas is selected by the user, the method will perform the steps S24˜S34 again to obtain a second image to replace the previously displayed first image. If the user does not want to select another specific lattice area, the user can press any key of the image capturing apparatus 1 to jump out of the lattice area selection function, and the first image will be stored in the storage module 20.

Compared to the prior art, the image capturing apparatus and the image processing method applied to the image capturing apparatus of the invention are to capture a plurality of images corresponding to different focus distances respectively, and then divide each image into a plurality of lattice areas and calculate sharpness value of each lattice area for the user to select the lattice area to be focused, and automatically find the best focus distance corresponding to the selected lattice area and the clearest image corresponding to the best focus distance and then display the clearest image. Therefore, complicated operation procedures are unnecessary when the user takes pictures. The user only needs to select the auto-focusing process, the high-speed focusing process, or video recording process, and then press the shutter button down halfway (the auto-focusing process) or fully press the shutter button down (the high-speed focusing process or video recording process) to take pictures having different focus points for the same scene. When the user wants to view the pictures corresponding to different selected focus point positions, the user only needs to select different lattice areas on the monitor of the digital camera, an then the monitor will display pictures having different shallow depth of field effects for the user to select one.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An image processing method applied to an image capturing apparatus, the image processing method comprising steps of:
(a)continuously capturing a plurality of images corresponding to different focus distances;
(c)selecting one of the plurality of images as an initial display image and dividing the initial display image into a plurality of lattice areas;
(d)using a specific lattice area of the plurality of lattice areas in the initial display image to compare sharpness values of areas corresponding to the specific lattice area in the plurality of images corresponding to the different focus distances to generate a comparison result; and
(e)selecting a first image from the plurality of images corresponding to the different focus distances according to the comparison result and displaying the first image selected to replace the initial display image previously displayed.

2. The image processing method of claim 1, wherein in the step (c), if a central lattice area or a lattice area corresponding to a focus indicator box of an image among the plurality of images has a maximum sharpness value, the image is selected as the initial display image.

3. The image processing method of claim 1, wherein the comparison result generated in the step (d) is shown in a sharpness-focus distance distribution curve.

4. The image processing method of claim 3, wherein in the step (e), the first image is selected from the plurality of images according to a best focus distance corresponding to a maximum sharpness value of the sharpness-focus distance distribution curve of the specific lattice area.

5. The image processing method of claim 4, wherein the best focus distance corresponding to each lattice area is stored in a texture file or an exchangeable image file format (EXIF) information of the plurality of images.

6. The image processing method of claim 4, wherein the best focus distance corresponding to each lattice area and the plurality of images are stored in a video file or a multi-file format.

7. The image processing method of claim 1, further comprising following steps of:
providing a plurality of lattice areas of the first image while the first image is displayed;
when another specific lattice area of the plurality of lattice areas is selected, comparing sharpness values of areas corresponding to the another specific lattice area in the plurality of images corresponding to the different focus distances to generate another comparison result;
selecting a second image from the plurality of images according to the another comparison result; and
displaying the second image selected to replace the first image previously displayed, wherein the second image is different from the first image.

8. The image processing method of claim 1, wherein the step (a) is achieved by a way of high-speed continuous shooting or video recording or performed in an auto-focusing process.

9. The image processing method of claim 1, further comprising a step (b) between the step (a) and the step (c), and the step (b) comprising steps of:
dividing each of the plurality of images into the plurality of lattice areas respectively and calculating the sharpness value in each of the plurality of lattice areas respectively;
judging whether sharpness values of all lattice areas of at least two adjacent images of the plurality of images are the same;
if the judgment result is yes, canceling one of the images having the same sharpness values of all lattice areas; and
if the judgment result is no, keeping some of the images having different sharpness values of all lattice areas.

10. The image processing method of claim 9, wherein in the step (b), each image is divided into (A*B) lattice areas, both A and B are positive integers.

11. The image processing method of claim 1, wherein the step (c) and the step (d) further comprise steps of:
dividing the initial display image into the plurality of lattice areas in a way that the plurality of lattice areas divided can be selected respectively; and
when a lattice area is selected from the plurality of lattice areas, using the selected lattice area as the specific lattice area.

12. An image capturing apparatus, comprising:
an image capturing module, the image capturing module continuously capturing a plurality of images corresponding to different focus distances;
a micro processor, coupled to the image capturing module; and
a display module, coupled to the micro processor, the display module displaying an initial display image of the plurality of images;
wherein the micro processor divides the initial display image into a plurality of lattice areas and uses one of the plurality of lattice areas as a specific lattice area, the micro processor compare sharpness values of areas corresponding to the specific lattice area in the plurality of images corresponding to the different focus distances to generate a comparison result and selects a first image from the plurality of images according to the comparison result, and then the display module will display the first image to replace the initial display image previously displayed.

13. The image capturing apparatus of claim 12, wherein if a central lattice area or a lattice area corresponding to a focus indicator box of an image among the plurality of images has a maximum sharpness value, the image is selected as the initial display image.

14. The image capturing apparatus of claim 12, wherein the comparison result generated by the micro processor is shown in a sharpness-focus distance distribution curve and the first image is selected from the plurality of images according to a best focus distance corresponding to a maximum sharpness value of the sharpness-focus distance distribution curve.

15. The image capturing apparatus of claim 12, wherein when the display module displays the selected first image and the plurality of lattice areas of the first image and another specific lattice area of the plurality of lattice areas is selected, the micro processor compares the sharpness value of the another specific lattice area in each image to generate another comparison result and selects a second image from the plurality of images according to the another comparison result, and then the display module displays the second image selected to replace the first image previously displayed, wherein the second image is different from the first image.

16. The image capturing apparatus of claim 12, wherein the micro processor divides each of the plurality of images into the plurality of lattice areas respectively and calculating the sharpness value in each of the plurality of lattice areas respectively, after the sharpness value of each lattice area is calculated by the micro processor, the micro processor judges whether sharpness values of all lattice areas of at least two adjacent images of the plurality of images are the same; if the judgment result is yes, the micro processor cancels one of the images having the same sharpness values of all lattice areas; if the judgment result is no, the micro processor keeps some of the images having different sharpness values of all lattice areas.

17. The image capturing apparatus of claim 12, wherein the micro processor divides the initial display image into the plurality of lattice areas in a way that the plurality of lattice areas divided can be selected respectively and when a lattice area is selected from the plurality of lattice areas, the micro processor uses the selected lattice area as the specific lattice area.
